(19) United States
(12) Patent Application Publication
(10) Pub. No.: US 2007/0201303 A1
(43) Pub. Date: Aug. 30, 2007

(54) METHOD AND APPARATUS FOR MAKING NON-STAINING BEVERAGES

(76) Inventors: Steve H. KANZER, Ann Arbor, MI (US); John S. Althaus, Ann Arbor, MI (US)

Correspondence Address: HAYES SOLOWAY P.C., 3450 E. SUNRISE DRIVE, SUITE 140, TUCSON, AZ, 85718, US

(21) Appl. No.: 11/626,313

(22) Filed: Jan. 23, 2007

Related U.S. Application Data
(60) Provisional application No. 60/761,253, filed on Jan. 23, 2006.

(51) Int. Cl. B01F 15/00

(52) U.S. Cl. 366/129

(57) ABSTRACT

A method and apparatus for making non-staining coffee or tea includes an ion exchanger for removing heavy metals from the brewed coffee or tea or from the water used to brew the coffee or tea.

### CROSS REFERENCE TO RELATED APPLICATION

This application claims priority from U.S. Provisional Application Ser. No. 60/761,253, filed Jan. 23, 2006.

### FIELD OF THE INVENTION

This invention relates generally to a method and apparatus for making non-staining beverages. The invention has particular utility when used in the making of coffee, and will be described in connection with such utility, although other utilities are contemplated.

### BACKGROUND OF THE INVENTION

Many coffee drinkers experience a brown-yellow coloration or staining of their teeth over time. This staining is both cosmetically undesirable, and is unhealthy since bacteria in the mouth may adhere to the stains, contributing to tartar build-up, bone recession and loss of teeth. Last year alone Americans spent over one billion dollars on whitening their teeth. Many more billions of dollars were spent on tartar removal.

### SUMMARY OF THE INVENTION

The present invention provides a method and apparatus for reducing staining of teeth from coffee and other beverages. More particularly, the present invention provides a method and apparatus for removing heavy metals dissolved in the water or contained within the coffee bean itself. While not wishing to be bound by theory, it is believed that heavy metals dissolved in the water used to prepare coffee or heavy metals contained in the coffee bean itself may act as catalysts resulting in the staining of biogenic phosphate structures such as teeth. In one embodiment, the present invention removes heavy metals from the water used to brew the coffee or from the brewed coffee through ion exchange. In another embodiment, the present invention removes heavy metals from the water used to brew the coffee or from the brewed coffee through metal chelation.

In one embodiment of the invention, the ion exchanger or metal chelator may be incorporated onto or imbedded within a standard coffee filter, filter pack, or filter cartridge.

The standard disposable coffee filter of the prior art is typically pleated or conical in shape. It is typically fabricated from porous paper and is sized to fit within various standard coffee filter holders of coffee brew machines. One example is a pleated disposable coffee filter, as shown in FIG. 1, which has a depth of 2″ and a base of 3″ and is made to fit 1-4 cup coffee makers. Other standard coffee filters of the prior art are reusable or “permanent”.

A disposable coffee filter may also be a “filter pack” as described in U.S. Pat. Nos. 5,012,629 and 5,298,267. These packs are typically pouches which are made from heat sealable filter paper or from non-woven polyester, polypropylene, polyethylene or a combination thereof. Each pack contains a predetermined volume of roast and ground coffee suitable for brewing a single pot of coffee of reasonably consistent strength from one pot to the next.

A disposable coffee filter may also be disposed within the base of a “filter cartridge”, as described in U.S. Pat. Nos. 5,325,765 and 5,840,189. Such a filter may be made of paper of cellulosic and synthetic fibers such as PVC or polypropylene. These filter cartridges are commonly referred to as “K-cups®” or “pods”.

In an alternative embodiment of the invention, the ion exchanger or metal chelator may be incorporated into a disposable disc or other disposable piece which may be placed upon or inserted within any standard disposable filter, reusable filter, filter pack, or filter cartridge of the prior art.

In an embodiment of the invention, the ion exchanger or metal chelator may be carried on or imbedded within a disposable stirrer or spoon or the like, coated on or in the interior surface of a disposable coffee cup or container, or packaged with the coffee in a filter bag or the like. Incorporation of ion exchange property to the apparatus may involve modification of a surface or fusion of two or more surfaces. In the case of fusing one or more surfaces, one surface/s would act as a base and another surface/s would act as a substrate containing the ion exchange property. An example would be an ion exchange paper carried on a wooden stirrer or the like.

The metal chelator of the present invention may be a chelator suitable for the removal of metals such as iron and copper. In one embodiment of the invention, the chelator is phytic acid.

### BRIEF DESCRIPTION OF THE DRAWINGS

Other features and advantages of the present invention will be seen from the following detailed description, taken in conjunction with the accompanying drawings wherein like numerals depict like parts, and wherein:

FIG. 1 is a perspective view of a pleated paper filter made in accordance with one embodiment of the present invention;

FIGS. 2-6 are grey scales showing staining against a control;

FIG. 7 is a side elevational view of a pre-filled coffee bag made in accordance with another embodiment of the present invention;

FIG. 8 is a perspective view of a disposable coffee cup made in accordance with the present invention;

FIGS. 9 and 9A are side elevational views of stirring rods made in accordance with the present invention; and

FIG. 10 is a side elevational view of a stirring spoon made in accordance with the present invention.

### DETAILED DESCRIPTION OF PREFERRED EMBODIMENT

As noted above, the present invention is based on the theory that heavy metals dissolved in the water used to prepare coffee or heavy metals contained within the coffee bean itself act as catalysts promoting the staining of biogenic phosphate structures such as teeth. Whatever the mechanism, it has been found that treating the water used to prepare the coffee or treating the brewed coffee with an ion exchanger or metal chelator substantially eliminates staining of phosphate structures including natural and synthetic hydroxyapatite component of teeth upon exposure to coffee.

In order to simulate accelerated staining tests, broken pieces of white sea shells were placed in brewed coffee samples for a period of time. Ionic copper in the form of copper sulfate was added to some of the samples to simulate heavy metal contamination. The sea shells were soaked for 30 minutes or less in the brewed coffee, and the sea shells were then inspected for discoloration.

It was observed that copper added to coffee caused white sea shells that were placed in the coffee to take on a brown discoloration. However, if the coffee containing copper is first exposed to an ion-exchanger before placing sea shells into the coffee, then discoloration is eliminated. Similar results are found if coffee is made with tap water only and no added copper sulfate. In this case, untreated coffee produces brown discoloration after exposure of shells in brewed coffee for 5 days. However, the same coffee treated with an ion-exchanger results in little or no discoloration of exposed sea shells.

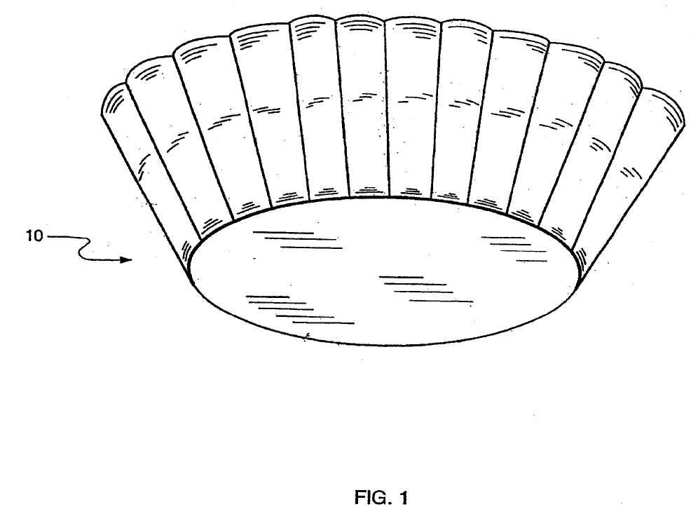

The overall process involved brewing coffee in an automatic brewer, substituting for the conventional pleated coffee filter, a coffee filter formed from ion exchange filter paper (Watman Number P-81 filter paper) available from Oy Watman AB (Finland). According to the manufacturer, Watman Number P-81 filter paper is characterized by the following properties:
Thin (0.23 mm) paper with cellulose phosphate functional groups
High-capacity, strong cation exchanger for separation of biogenic amines, antibiotics, histamines, and certain metallic cations at very low concentrations
Flowrate, 125 mm/30 min. (in water)
Ion exchange capacity is 18.0 μEq/cm
Manufactured from pure cellulose and ion-exchange cellulose fibers to permit highly efficient, rapid separations of charged organic or inorganic substances
   The filter paper was formed into a pleated filter 10 as seen in FIG. 1, and the pleated filter used to brew coffee in a conventional automatic coffee brewer. Broken white sea shells were placed in the brewed coffee, and the coffee stored for a period of time, and the sea shells were then examined for discoloration.

For better understanding of the invention, the following particular examples are now given:

### EXAMPLE 1

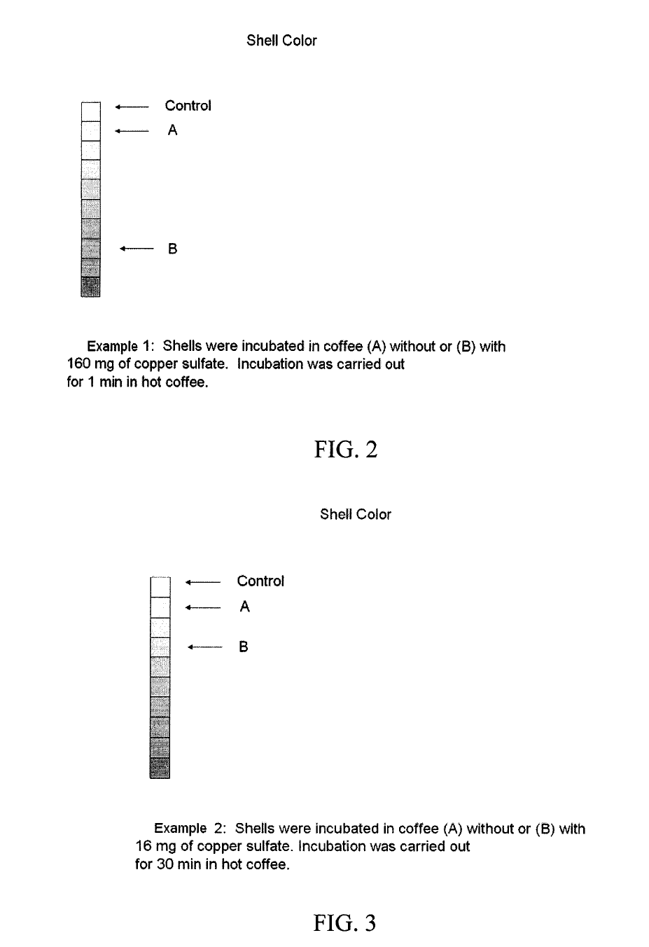

Generic white seashells were broken into pieces that were about ½″ by ½″ square. Three cups of distilled water were poured into a single glass container. Three rounded teaspoons of Maxwell House® instant coffee were added to the water. The container and contents were heated in a microwave oven at full power for 1 min. The solution was further mixed with a plastic spoon. One cup each of the solution was poured into two identical coffee mugs. To one mug was added 160 mg of CuSO₄. Two shell pieces that shared a common edge were placed one piece per mug into their respective solutions. Each mug was heated one at a time for 1 min in a microwave set at full power. After 1 min of heating each shell piece was removed, rinsed in a cup of distilled water and dried. Any staining that occurred appeared within a spectrum of various shades of brown. This spectrum has been duplicated in the grey scale above. The intensity of staining for each shell piece labeled as control (no treatment), A (without copper) or B (with copper) is designated on the grey scale shown in FIG. 2.

### EXAMPLE 2

Generic white seashells were broken into pieces that were about ½″ by ½″ square. Three cups of distilled water were poured into a single glass container. Three rounded teaspoons of Maxwell House® instant coffee were added to the water. The container and contents were heated in a microwave oven at full power for 1 min. The solution was further mixed with a plastic spoon. One cup each of the solution was poured into two identical coffee mugs. To one mug was added 16 mg of CuSO₄. Two shell pieces that shared a common edge were placed one piece per mug into their respective solutions. Each mug was heated one at a time for 1 min in a microwave set at full power. After 1 min of heating the mugs were allowed to stand at room temperature for 30 additional min. Each shell piece was then removed, rinsed in a cup of distilled water and dried. Any staining that occurred appeared within a spectrum of various shades of brown. This spectrum has been duplicated in the grey scale above. The intensity of staining for each shell piece labeled as control (no treatment), A (without copper) or B (with copper) is designated on the grey scale shown in FIG. 3.

### EXAMPLE 3

Generic white seashells were broken into pieces that were about ½″ by ½″ square. One cup of distilled water each was poured into two identical ceramic mugs. To one mug of water was added 160 mg of CuSO₄. The CuSO₄ was dissolved in its mug of water by stirring with a plastic spoon. Two shell pieces that shared a common edge were placed one piece per mug into their respective water solutions. Each mug was heated one at a time for 1 min in a microwave set at full power. After 1 min of heating, each shell piece was then removed, rinsed in a cup of distilled water and dried. Three cups of distilled water were then poured into a single glass container. Three rounded teaspoons of Maxwell House® instant coffee were added to the water. The container and contents were heated in a microwave oven for 1 min. The solution was further mixed with a plastic spoon. One cup each of the solution was poured into two identical coffee mugs. The two shell pieces from the previous water treatment step were placed one piece per mug into their respective solutions. Each mug was heated one at a time for 1 min in a microwave set at full power. After 1 min of heating each shell piece was then removed, rinsed in a cup of distilled water and dried. Any staining that occurred appeared within a spectrum of various shades of brown. This spectrum has been duplicated in the grey scale above. The intensity of staining for each shell piece labeled as control (no treatment), A (without copper) or B (with copper) is designated on the grey scale shown in FIG. 4.

### EXAMPLE 4

Generic white seashells were broken into pieces that were about ½″ by ½″ square. Three cups of distilled water were poured into a single glass container. Three rounded teaspoons of Maxwell House® instant coffee were added to the water. In addition, 144 mg of CuSO₄ was added to the solution. The container and contents were heated in a microwave oven for 1 min. The solution was further mixed with a plastic spoon. A 7 inch diameter circle was cut from a sheet of Whatman P-81 ion exchange paper. The circle of paper was fluted and placed into a glass container. Two cups of the coffee/copper mixture were poured into the fluted paper. When one cup of liquid was collected, it was poured into a separate mug. A second identical mug was filled with 1 cup of the unfiltered coffee/copper solution. Two shell pieces that shared a common edge were placed one piece per mug into their respective solutions. Each mug was heated one at a time for 1 min in a microwave set at full power. After 1 min of heating each shell piece was then removed, rinsed in a cup of distilled water and dried. Any staining that occurred appeared within a spectrum of various shades of brown. This spectrum has been duplicated in the grey scale above. The intensity of staining for each shell piece labeled as control (no treatment), A (filtered) or B (unfiltered) is designated on the grey scale shown in FIG. 5.

### EXAMPLE 5

Generic white seashells were broken into pieces that were about ½″ by ½″ square. Three cups of tap water were poured into a single glass container. Three rounded teaspoons of Maxwell House® instant coffee were added to the water. The container and contents were heated in a microwave oven for 1 min. The solution was further mixed with a plastic spoon. A 7 inch diameter circle was cut from a sheet of Whatman P-81 ion exchange paper. The circle of paper was fluted and placed into a glass container. Two cups of the coffee/tap water mixture were poured into the fluted paper. When one cup of liquid was collected, it was poured into a separate mug. A second identical mug was filled with 1 cup of the unfiltered coffee/tap water solution. Two shell pieces that shared a common edge were placed one piece per mug into their respective solutions. Each mug was heated one at a time for 1 min in a microwave set at full power. After 1 min of heating the mugs were allowed to stand at room temperature for 5 additional days. Each shell piece was then removed, rinsed in a cup of distilled water and dried. Any staining that occurred appeared within a spectrum of various shades of brown. This spectrum has been duplicated in the grey scale above. The intensity of staining for each shell piece labeled as control (no treatment), A (filtered) or B (unfiltered) is designated on the grey scale shown in FIG. 6.

### EXAMPLE 6

Repeat Example 1 with false teeth provides similar results.

It is thus seen that treating brewed coffee or the water used to brew the coffee with an ion exchanger to remove heavy metals reduces staining of biogenic phosphate structures including teeth.

The invention is susceptible to modification. For example, various other filter papers formed of cellulose derivatized so that it possesses ion-exchange properties may be used. These derivates of cellulose include, but are not limited to phospho-cellulose, sulfo-cellulose and carboxylate-cellulose. Non-cellulose filter materials having ion exchangers also may be used.

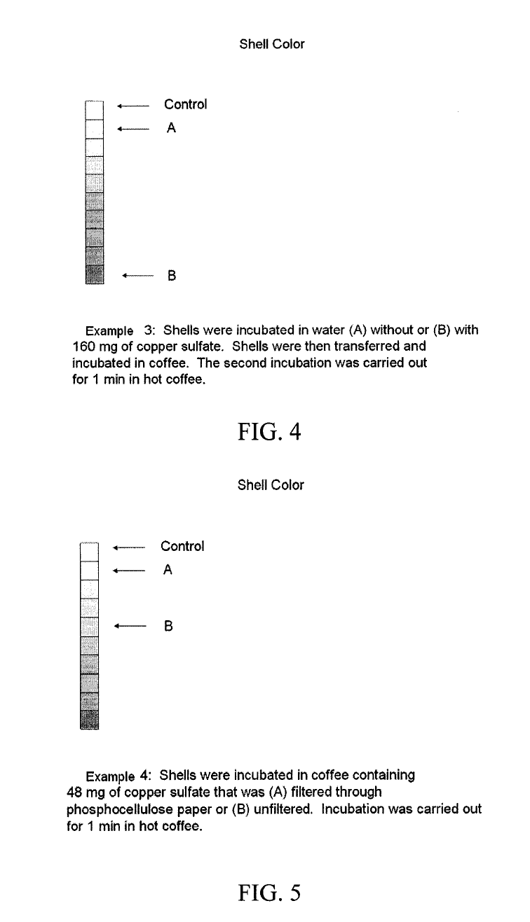

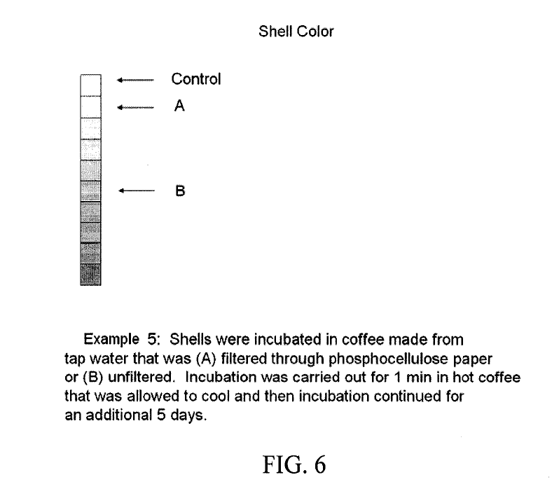

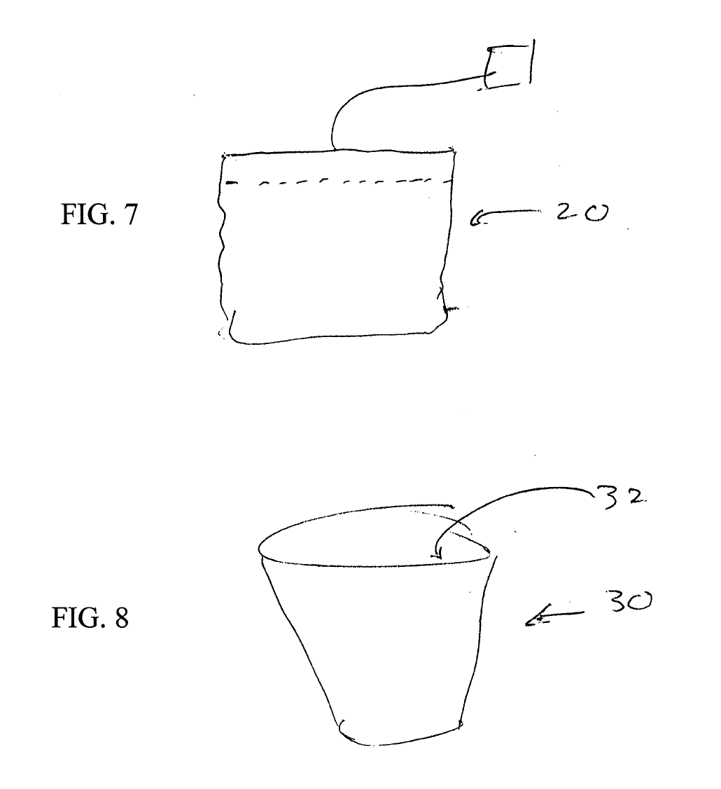

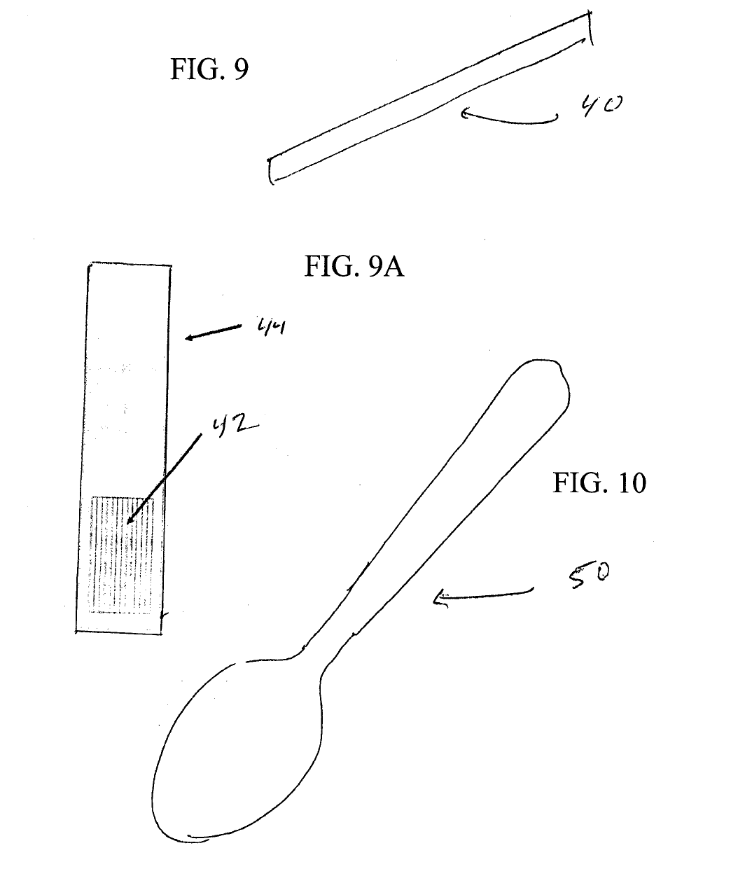

In another embodiment of the invention, a filter material having ion exchange properties may be used to form a flow-through filter bag or pod 20 as shown in FIG. 7 for containing coffee. The bag or pod may then be used in place of the conventional filter in a coffee brewer, or the filter bag or pod placed directly in a cup of a water and steeped for a period of time. In yet another embodiment of the invention, an ion exchanger may be coated on the interior surface 30 of a disposable coffee cup 32 as shown in FIG. 8. Alternatively, an ion exchanger may be coated on a surface of a stirring stick 40 as shown in FIG. 9 or on a disposable spoon 50 as shown in FIG. 10. In yet another embodiment of the invention, an ion exchange paper 42 may be fitted to a wooden or plastic stirrer 44 as shown in FIG. 9A.

### EXAMPLE 7

Cation Exchange Coffee Filters Made from Phytic Acid

### I. INTRODUCTION

Cation exchange coffee filters were prepared by procedure that involved soaking standard coffee filters in a solution of sodium phytate followed by baking the phytate saturated coffee filters. Filter column were then prepared using treated and non-treated coffee filters. When a copper solution was allowed to drip through the filter columns, only the filter column containing coffee filters treated with phytate completely retained copper. Coffee filters not treated with phytate allowed 100% of copper from a solution to pass. These results show that standard coffee filters treated with phytate are capable removing copper from a solution when filtered.

### II. METHODS

a. Preparation of Cation Exchange Coffee Filters

Cation exchange coffee filters were prepared as follows. Generic coffee filters for use in a drip-style coffee maker were purchased. Coffee filters were then soaked in a solution of 1 M sodium phytate. After 5 minute of soaking, excess liquid was removed and filters were dried in an oven at 60° C. for 30 minutes. After drying, filters were baked in an oven at about 180° C. for 20 minutes. After baking, filters were removed and it was observed that the filters had acquired a brown heu coloration. These brown filters were then rinsed thoroughly with distilled water and dried in an oven at 60° C. for 30 minutes.

b. Preparation of Filter Columns

Filter Columns were made from both treated and non-treated coffee filters. Rectangular pieces of material that were about 1 inch by 6 inches were cut from both treated and non-treated coffee filters. These materials were rolled tightly into plugs that were about 1 inch tall and about ¼ inch in diameter. These plugs were inserted into 1 ml plastic pipette tips. The plugs were secured to the pipette tip using a plastic rod to bush the plug until a tight fit was obtained.

c. Preparation of Copper Testing Reagents.

Copper testing reagents were prepared as follows. 10 mg of sodium bathocuprionedisulfonate (BA solution), (a specific calorimetric chelator of copper) and 10 mg of ascorbate were dissolved in 10 ml of distilled water. A copper solution was prepared as a 1 part per thousand solution by dissolving copper sulfate in distilled water.

d. Method for Testing Filter Columns for Copper Chelation.

200 ul of copper sulfate (1 ppt) was applied to filter columns containing treated and non-treated coffee filters. The effluent from each column was collected and tested for copper content. Copper testing was performed by transferring 100 ul of effluent or copper sulfate solution to tubes containing 900 ul of BA solution. Tubes were then visually inspected for the appearance of an orange color.

### III. RESULTS

a. When 100 ul of the copper sulfate solution was added directly to 900 ul of a BA solution, the color immediately changed from clear to dark orange.

b. When 100 ul of the effluent solution from the non-treated filter column was added to 900 ul of a BA solution, the color immediately changed from clear to dark orange.

c. The dark orange color found for Results “a” was not different from the dark orange color found for Results “b”.

d. When 100 ul of the effluent solution from the treated filter column was added to 900 ul of a BA solution, the color of the resulting solution remained unchanged.

### IV. CONCLUSION

Coffee filters that were treated with sodium phytate completely removed the copper from a solution that contained copper at a concentration that was 1 part per thousand.

### EXAMPLE 8

Removal of copper from coffee using phytate-treated coffee filters.

Cation exchange coffee filters were prepared by a procedure that involved soaking standard coffee filters in a solution of sodium phytate followed by baking the phytate-saturated coffee filters. Filter columns were then prepared using treated and non-treated coffee filters. When coffee that was prepared using tap water was allowed to drip through the filter columns, only the filter column containing coffee filters treated with phytate removed substantial amounts of copper from the coffee. Coffee filters not treated with phytate allowed most of the copper to pass with the coffee. These results show that standard coffee filters treated with phytate are capable of removing substantial amounts of copper from coffee when filtered.

Cation exchange coffee filters were prepared as follows. Generic coffee filters for use in a drip-style coffee maker were used in this example. Coffee filters were then soaked in a solution of 1 M sodium phytate. After 5 minute of soaking, excess liquid was removed and filters were dried in an oven at 60° C. for 30 minutes. After drying, filters were baked in an oven at about 180° C. for 20 minutes. After baking, filters were removed and it was observed that the filters had acquired a brown hue coloration. These brown filters were then rinsed thoroughly with distilled water and dried in an oven at 60° C. for 30 minutes.

Filter columns were made from both treated and non-treated coffee filters. Rectangular pieces of material that were about 1 inch by 6 inches were cut from both treated and non-treated coffee filters. These materials were rolled tightly into plugs that were about 1 inch tall and about ¼ inch in diameter. These plugs were inserted into 1 ml plastic pipette tips. The plugs were secured to the pipette tip using a plastic rod to bush the plug until a tight fit was obtained.

Copper content in coffee was measured using an electrochemical potentiostat. Coffee was brewed using tap-water. This coffee was then filtered through filter columns that contained treated and un-treated coffee filters. Unfiltered coffee and coffee that was filtered using filter columns was tested for copper using an electrochemical potentiostat. Coffee samples were diluted 1 to 10 in 0.1 N HCl. 100 ul of this solution was applied to a carbon electrode (with silver reference electrode) designed to measure heavy metals that was connected to a potentiostat. A deposition potential of −2 V was applied to the solution. After 6 minutes of deposition, square wave voltammetry was used to create a current-potential curve that was proportional to the amount of copper in solution. Peak current specific to copper occurred at approximately −0.3 volts. The amount of copper was proportional to the peak height of the current-potential curve for copper.

Results: The peak height measured from unfiltered coffee was about ˜2 microamps. For coffee filtered through untreated filter paper, the peak height for copper measurement was about ˜1.8 microamps. For coffee filtered through phytate-treated filter paper, the peak height for copper measurement was about 0.2 microamps.

Accordingly, coffee filters that were treated with sodium phytate removed about 90% of the copper from coffee brewed using tap water.

Yet other utilities are possible. For example, while the invention above has been described in connection with removing heavy metals from coffee, the invention also advantageously may be employed for removing heavy metals from tea, or bouillon, or other beverages.

In addition to the foregoing, the invention provides certain health benefits in removing heavy metals, such as copper, from beverages. Several conditions have traditionally led to copper toxicity, including contaminated water sources, [Turnlund, J R Copper. In: Modern nutrition in health and disease. Shils, M E, Olson, J A, Shike, M (Eds), et al. Lippincott, Philadelphia 2000. p. 241]. Clinical manifestations of severe toxicity include hepatic necrosis, coma, oliguria, renal failure, hypotension, and even death. Mild gastrointestinal symptoms such as nausea, vomiting, and abdominal pain can occur in less acute and less serious toxic conditions. The World Health Organization (WHO) recommends intakes of less than 10 mg per day for women and 12 mg per day for men as the safe cutoffs [World Health Organization. Copper. In: Trace elements in human nutrition and health, World Health Organization, Geneva 1996. p. 123]. Treating a beverage as set forth above removes such deleterious heavy metals.

Yet other features and advantages of the present invention would be apparent to those skilled in the art.

1. A method for reducing staining of biogenic phosphate structures exposed to aqueous solutions which comprises treating the aqueous solution with an ion exchanger or metal chelator to remove heavy metals.

2. A method as claimed in claim 1, wherein the aqueous solution comprises brewed coffee or tea.

3. The method of claim 2, wherein the coffee or tea is treated following or during brewing.

4. The method of claim 2, wherein the water used to brew the coffee or tea is treated prior to brewing.

5. A coffee filter containing an ion-exchanger or metal chelator for removing heavy metals.

6. The coffee filter as claimed in claim 5, wherein the filter is formed of a derivatized cellulose.

7. The coffee filter as claimed in claim 6, wherein the derivatized cellulose is selected from the group consisting of a phospho-cellulose, a sulfo-cellulose and a carboxylate-cellulose.

8. A cup or container for a beverage having an ion exchanger or metal chelator on an interior surface thereof.

9. A beverage stirrer having an ion exchanger or metal chelator on a surface thereof.

10. The stirrer as claimed in claim 9, in the form of a stirring stick or a spoon.

11. The stirrer as claimed in claim 9, wherein the ion exchanger comprises an ion exchange paper carried on a surface of the stirrer.

12. A filter suitable for an automatic drip coffee maker which comprises at least one metal chelator or ion exchanger.

13. The filter as claimed in claim 12, wherein the chelator or exchanger is suitable for the removal of iron or copper.

14. The filter as claimed in claim 12, wherein the filter is made substantially of paper.

15. The filter as claimed in claim 12, wherein the chelator is phytic acid.

16. A composition which comprises a metal chelator or ion exchanger and which may be imbedded within a coffee filter.

17. The method as claimed in claim 1, wherein the chelator is phytic acid.

18. The filter as claimed in claim 5, wherein the chelator is phytic acid.

19. The cup or container as claimed in claim 8, wherein the chelator is phytic acid.

20. The stirrer as claimed in claim 9, wherein the chelator is phytic acid.

21. The composition as claimed in claim 16, wherein the chelator is phytic acid.
